(19) United States
(12) Patent Application Publication
(10) Pub. No.: US 2014/0340779 A1
(43) Pub. Date: Nov. 20, 2014

(54) DATA STORAGE APPARATUS AND DATA STORAGE CONTROL METHOD

(71) Applicant: KABUSHIKI KAISHA TOSHIBA, MINATO-KU (JP)

(72) Inventor: Shinichi KANNO, Tokyo (JP)

(73) Assignee: KABUSHIKI KAISHA TOSHIBA, MINATO-KU (JP)

(21) Appl. No.: 14/012,313

(22) Filed: Aug. 28, 2013

(30) Foreign Application Priority Data
May 17, 2013 (JP) 2013-104961

(51) Int. Cl. G11B 27/10

(52) U.S. Cl. CPC G11B 27/105
USPC 360/49

(57) ABSTRACT

According to one embodiment, a magnetic disk, a semiconductor memory, and a controller are installed. In the magnetic disk, writing is performed in units of band which is a collection of a plurality of adjacent tracks. The semiconductor memory caches data written in the magnetic disk. The controller manages the data cached in the semiconductor memory in units of capacity which is smaller than capacity of the band.

### CROSS-REFERENCE TO RELATED APPLICATIONS

This application is based upon and claims the benefit of priority from Japanese Patent Application No. 2013-104961, filed on May 17, 2013; the entire contents of which are incorporated herein by reference.

### FIELD

Embodiments of the present invention relate to a data storage apparatus and a data storage control method.

### BACKGROUND

In order to increase storage capacity of a magnetic disk apparatus, there is a method of performing overlapped recording data on a portion of adjacent tracks. Sometimes, the method is referred to as shingled recording. In the shingled recording, in the following track, some of data of the track where overlapped writing is performed on the portion thereof is lost. In the shingled recording, writing is performed in units of band which is a collection of a plurality of adjacent tracks.

### BRIEF DESCRIPTION OF THE DRAWINGS

FIG. 1 is a cross-sectional view illustrating a schematic configuration of a data storage apparatus according to a first embodiment;

FIG. 2A is a plan view illustrating an example of a configuration of bands of a magnetic disk of FIG. 1;

FIG. 2B is a diagram illustrating an example of arrangement of tracks in the band of FIG. 2A;

FIG. 3A is a plan view illustrating an example of write positions during random write period of the magnetic disk of FIG. 2A;

FIG. 3B is a diagram illustrating a cache state of data written in the magnetic disk of FIG. 3A;

FIG. 3C is a diagram illustrating content of a cache management table corresponding to the cache state of FIG. 3B;

FIG. 3D is a diagram illustrating content of a dirty counter corresponding to the write positions of FIG. 3A;

FIG. 3E is a diagram illustrating a method of allocating a hash value to a logical block address;

FIG. 4A is a plan view illustrating an example of write positions during random write period of the magnetic disk of FIG. 2A;

FIG. 4B is a diagram illustrating a cache state of data written in the magnetic disk of FIG. 4A;

FIG. 4C is a diagram illustrating content of a cache management table corresponding to the cache state of FIG. 4B;

FIG. 4D is a diagram illustrating content of a dirty counter corresponding to the write positions of FIG. 4A;

FIG. 4E is a diagram illustrating content of the cache management table updated after the cache data of FIG. 4B are written in the magnetic disk;

FIG. 4F is a diagram illustrating content of the dirty counter updated after the cache data of FIG. 4B are written in the magnetic disk; and

FIG. 5 is a flowchart illustrating process during data write period of the data storage apparatus of FIG. 1.

### DETAILED DESCRIPTION

In general, according to one embodiment, a magnetic disk, a semiconductor memory, and a controller are installed. In the magnetic disk, writing is performed in units of band which is a collection of a plurality of adjacent tracks. The semiconductor memory caches data written in the magnetic disk. The controller manages the data cached in the semiconductor memory in units of capacity which is smaller than capacity of the band.

Hereinafter, data storage apparatuses according to embodiments will be described in detail with reference to the attached drawings. The present invention is not limited to the embodiments.

### First Embodiment

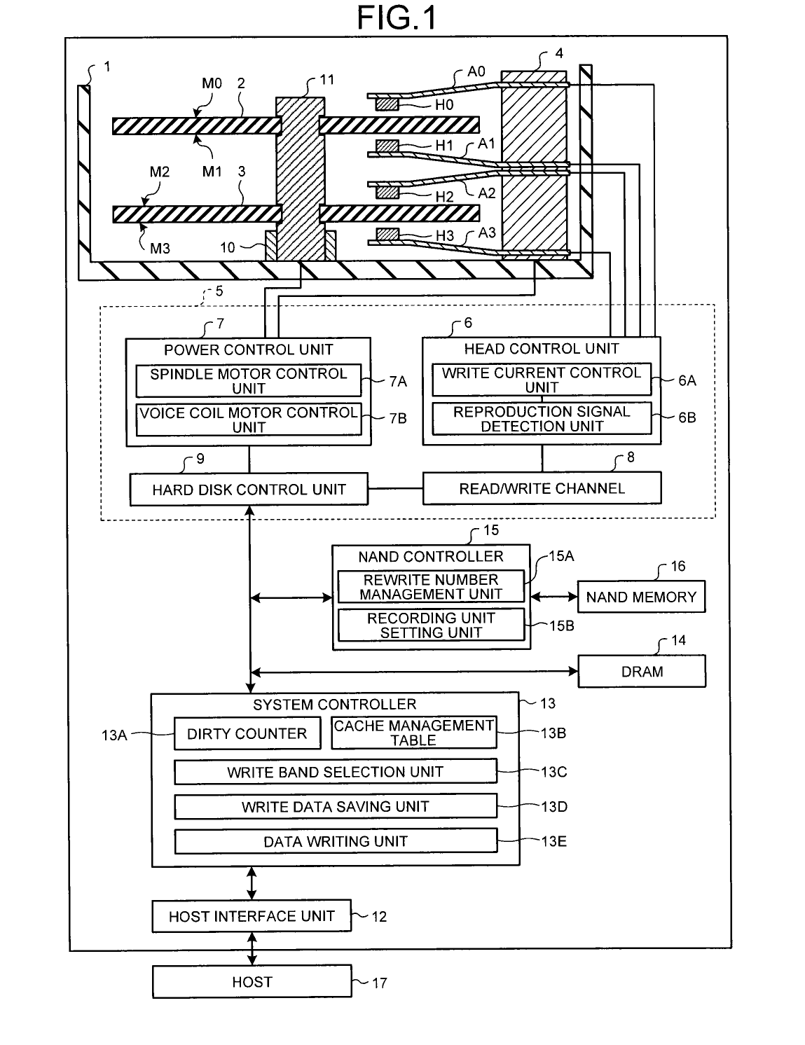

FIG. 1 is a block diagram illustrating a schematic configuration of a data storage apparatus according to a first embodiment.

In FIG. 1, a plurality of magnetic disks 2 and 3 is installed in a data storage apparatus, disk surfaces M0 and M1 are installed at both surfaces of the magnetic disk 2, disk surfaces M2 and M3 are installed at both surfaces of the magnetic disk 3. The magnetic disks 2 and 3 are integrally supported by a spindle 11. In the magnetic disks 2 and 3, writing is performed in units of band which is a collection of a plurality of adjacent tracks. In the case where writing is performed in units of band, shingled recording can be performed. Namely, in the shingled recording, overlapped recording is performed on a portion of adjacent tracks. Therefore, in the following track, some of data of the track where overlapped recording is performed on the portion thereof is lost. Due to the loss of data, even in the case where data recording is performed on any track, the recording is performed on all tracks in the band.

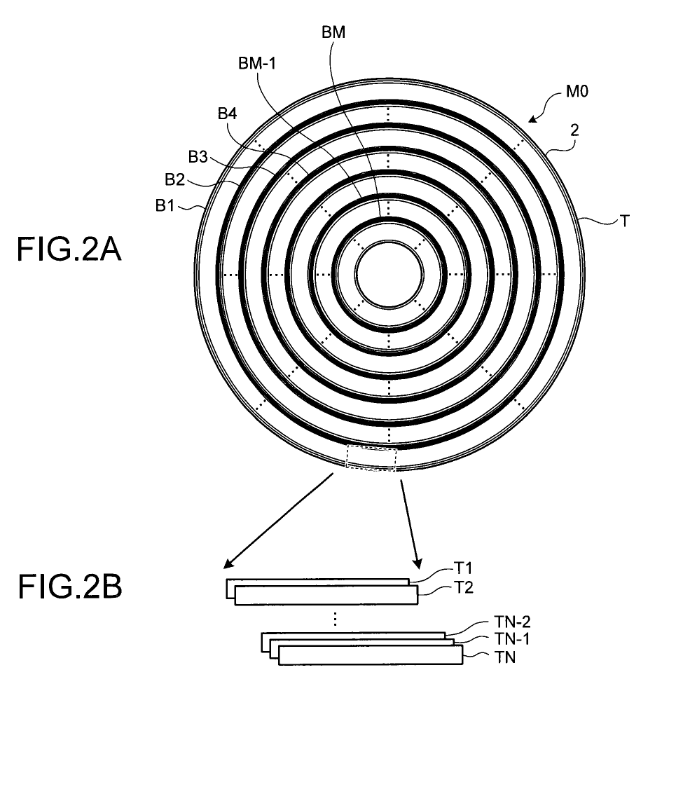

FIG. 2A is a plan view illustrating an example of a configuration of bands of the magnetic disk of FIG. 1, and FIG. 2B is a diagram illustrating an example of arrangement of tracks in the band of FIG. 2A.

In FIG. 2A, for example, tracks T are formed along the circumferential direction on the disk surface M0 of the magnetic disk 2. The disk surface M0 is divided into bands B1 to BM (M is an integer of 2 or more), each of which is a collection of a plurality of tracks T. As illustrated in FIG. 2B, between the adjacent tracks T in each of the bands B1 to BM, overlapped recording is performed on a portion of each of the tracks T1 to TN (N is an integer of 2 or more). The bands B1 to BM can be arranged so as not to overlap each other. In addition, in each of the bands B1 to BM, consecutive logical block addresses can be allocated.

In addition, in FIG. 1, in the data storage apparatus, magnetic heads H0 to H3 are installed for the respective disk surfaces M0 to M3, and the magnetic heads H0 to H3 are arranged so as to face the receptive disk surfaces M0 to M3. The magnetic heads H0 to H3 are supported on the respective disk surfaces M0 to M3 by respective arms A0 to A3. The arms A0 to A3 allow the respective magnetic heads H0 to H3 to slide on horizontal surfaces.

In addition, the data storage apparatus includes a voice coil motor 4 driving the arms A0 to A3 and a spindle motor 10 rotating the magnetic disks 2 and 3 through the spindle 11. The magnetic disks 2 and 3, the magnetic heads H0 to H3, the arms A0 to A3, the voice coil motor 4, the spindle motor 10, and the spindle 11 are retained within a case 1.

In addition, a magnetic recording control unit 5 is installed in the data storage apparatus, and the magnetic recording control unit 5 includes a head control unit 6, a power control unit 7, a read/write channel 8, and a hard disk control unit 9. The head control unit 6 includes a write current control unit 6A and a reproduction signal detection unit 6B. The power control unit 7 includes a spindle motor control unit 7A and a voice coil motor control unit 7B.

The head control unit 6 amplifies a signal during recording and reproducing periods. The write current control unit 6A controls write current flowing in the magnetic heads H0 to H3. The reproduction signal detection unit 6B detects signals read by the magnetic heads H0 to H3. The power control unit 7 drives the voice coil motor 4 and the spindle motor 10. The spindle motor control unit 7A controls rotation of the spindle motor 10. The voice coil motor control unit 7B controls driving of the voice coil motor 4. The read/write channel 8 converts a signal reproduced by the magnetic heads H0 to H3 into a data format which is to treated in a host 17 or converts data output from the host 17 into a signal format which is to recorded by the magnetic heads H0 to H3. As examples of this data conversion, there are DA conversion and encoding. In addition, the read/write channel 8 performs a decoding process on the signal reproduced by the magnetic heads H0 to H3 or code-modulates the data output from the host 17. The hard disk control unit 9 controls recording and reproducing based on commands from a system controller 13 or communicate data between the system controller 13 and the read/write channel 8.

In addition, the data storage apparatus is configured to include a host interface unit 12, the system controller 13, a DRAM 14, a NAND controller 15, and a NAND memory 16. The host interface unit 12 can receive a write command and a read command from the host 17 or can output read data read from the magnetic disks 2 and 3 or the NAND memory 16 to the host 17. The host interface unit 12 is connected to the host 17. The host 17 may be a personal computer which executes a write command or a read command in the magnetic disk apparatus, or the host 17 may be an external interface.

The NAND memory 16 caches data which are to be written in the magnetic disks 2 and 3. The NAND controller 15 can perform control of the NAND memory 16. As examples of the control of the NAND memory 16, there are read/write control, block selection, error correction, and the like of the NAND memory 16. The NAND controller 15 is configured to include a rewrite number management unit 15A and a recording unit setting unit 15B. The recording unit setting unit 15B sets capacity of a storage unit of data cached in the NAND memory 16 so as to be smaller than capacity of each of the bands B1 to BM. For example, in the case where the capacity of each of the bands B1 to BM is 100 MB, the capacity of a storage unit of the recording unit setting unit 15B may be set to be 4 kB. The rewrite number management unit 15A manages a rewrite number of the NAND memory 16 corresponding to each storage unit set by the recording unit setting unit 15B. The DRAM 14 may be used as a buffer to transmit the read data read from the NAND memory 16 to the host 17 or to receive the write data written in the NAND memory 16 from the host 17.

The system controller 13 can send commands for reading/writing data from/in the magnetic disks 2 and 3 to the hard disk control unit 9 or can send commands for reading/writing data from/in the NAND memory 16 to the NAND controller 15. The system controller 13, the host interface unit 12, the read/write channel 8, the NAND controller 15, and a CPU (not illustrated) may be configured, for example, with a SoC (system on-chip). The processes of the system controller 13 can be implemented by firmware executed by the CPU (not illustrated). The system controller 13 is configured to include a dirty counter 13A, a cache management table 13B, a write band selection unit 13C, a write data saving unit 13D, and a data writing unit 13E. The dirty counter 13A counts the number of data recorded in each of the bands B1 to BM based on a hash value extracted from a logical block address included in a write command and holds the count value corresponding to each of the bands B1 to BM. The cache management table 13B manages a correspondence relation between logical block addresses LBA included in the write command and cache areas FPB of the NAND memory 16. The write band selection unit 13C selects a write band of the magnetic disks 2 and 3 based on the count value of each of the bands B1 to BM. In the case where a data amount cached in the NAND memory 16 is smaller than the capacity of the write band, the write data saving unit 13D saves data written in an area which is not designated by a write command from the write band to an area where the rewrite number of the NAND memory 16 is equal to or larger than a predetermined value. The data writing unit 13E reads cached data and saved data from the NAND memory 16 and writes the cached data and saved data in the write bands of the magnetic disks 2 and 3.

Next, in the case where reading/writing of the magnetic disks 2 and 3 is performed, while the magnetic disks 2 and 3 are rotated by the spindle motor 10, signals are read from the disk surfaces M0 to M3 through the respective magnetic heads H0 to H3 and are detected by the reproduction signal detection unit 6B. The signals detected by the reproduction signal detection unit 6B are converted into data by the read/write channel 8, and then the data are transferred to the hard disk control unit 9. Next, the hard disk control unit 9 controls tracking of the magnetic heads H0 to H3 based on a burst pattern included in the signals detected by the reproduction signal detection unit 6B. In addition, current positions of the magnetic heads H0 to H3 are calculated based on sector/cylinder information included in the signals detected by the reproduction signal detection unit 6B and seek control is performed so that the magnetic heads H0 to H3 approach target positions.

On the other hand, in the case where writing is performed by using the NAND memory 16 as a write cache, the system controller 13 temporarily stores the write data supplied from the host 17 in the DRAM 14. Next, the NAND controller 15 transmits the write data stored in the DRAM 14 to the NAND memory 16 to write the write data in the NAND memory 16. In addition, in the case where writing in the NAND memory 16 as a write cache is performed, the system controller 13 may transmit/receive the write data supplied from the host 17 to/from the NAND controller 15 without temporarily storing the write data in the DRAM 14, and the NAND controller 15 may write the write data in the NAND memory 16.

In addition, in the case where reading is performed by using the NAND memory 16 as a read cache during read cache period, the NAND controller 15 reads the read data from the NAND memory 16 and temporarily stores the read data in the DRAM 14. Next, the system controller 13 transmits the read data stored in the DRAM 14 to the host 17. In addition, in the case where reading from the NAND memory 16 as a read cache is performed, the NAND controller 15 may transmit/receive the read data read from the NAND memory 16 to/from the system controller 13 without temporarily storing the read data in the DRAM 14, and the system controller 13 may transmit the read data to the host 17.

In the case where the system controller 13 receives the write command from the host 17, it is determined whether or not to cache the write data indicated by the write command in the NAND memory 16. Next, in the case where the write data are to be cached in the NAND memory 16, the system controller 13 instructs the NAND controller 15 to record the write data in the NAND memory 16. On the other hand, in the case where the write data are not to be cached in the NAND memory 16, the system controller 13 instructs the hard disk control unit 9 to record the write data in the magnetic disks 2 and 3.

In the case where the write data are to be cached in the NAND memory 16, the system controller 13 extracts a hash value from a logical block address expressed by a binary number included in the write command. The extraction of the hash value can be implemented by using a method of converting a logical block address into a value smaller than the logical block address according to a predetermined rule such as a method of extracting predetermined 1 or more bits and a method of calculating a remainder value obtained by dividing a logical block address by a predetermined value. Next, the dirty counter 13A counts the number of data recorded in each of the bands B1 to BM based on the hash value and holds the count value corresponding to each of the bands B1 to BM. In addition, the system controller 13 records a correspondence relation between logical block addresses included in the write command and cache areas of the NAND memory 16 in the cache management table 13B. Therefore, the NAND controller 15 manages data in a storage unit which is smaller than the capacity of each of the bands B1 to BM and manages the rewrite number of the NAND memory 16 corresponding to each storage unit. In addition, the system controller 13 monitors the count value of each of the bands B1 to BM every time when data are cached (stored) in the NAND memory 16. In the case where there is a band where the count value is larger than a reference value among the bands B1 to BM, the system controller 13 selects the band as a write band among the bands B1 to BM.

In the case where a data amount cached in the NAND memory 16 corresponding to the selected write band is smaller than the capacity of the write band, the system controller 13 saves data which are written in the area of the write band without designation by the write command to the area where the rewrite number of the NAND memory 16 is equal to or larger than a predetermined value. Next, the data cached in the NAND memory 16 and the data saved in the NAND memory 16 are read from the NAND memory 16, and the data are written in the write bands of the magnetic disks 2 and 3. In addition, the write band may be configured to be rewritten in the other bands rather than the band in which the saved data are recorded.

In the case where the data cached in the NAND memory 16 and the data saved in the NAND memory 16 are to be written in the selected write band, data can be read from the NAND memory 16 in random so that the data are sequentially written in the write band. This is because a data transmission rate of the reading from the NAND memory 16 is higher than that of the writing in the magnetic disks 2 and 3. More specifically, since the write speed of the magnetic disks 2 and 3 is in a range of several msec to several tens msec and the read speed of the NAND memory 16 is in a range of several μsec to tens μsec, the writing in the magnetic disks 2 and 3 can be performed while data are being read from the NAND memory 16 in random.

In addition, the data cached in the NAND memory 16 are managed in a storage unit smaller than the capacity of each of the bands B1 to BM, so that it is possible to reduce a seek time for the writing in units of band in random writing while suppressing an increase in buffer capacity for writing data back to the magnetic disks 2 and 3.

In addition, the data cached in the NAND memory 16 are written in the bands B1 to BM where the count value is larger than the reference value, so that an amount of new data among the data written in each of the bands B1 to BM can be increased. As a result, reordering efficiency is improved, so that a sum of seek times can be reduced.

In addition, when the data cached in the NAND memory 16 are to be written in the magnetic disks 2 and 3, data which are written in an area which is not designated by a write command are saved from the write band to the NAND memory 16, so that writing from the NAND memory 16 to the magnetic disks 2 and 3 can be performed in units of band. Therefore, the writing can be appropriately adapted to the shingled recording.

In addition, when data are to be saved from the write band to the NAND memory 16, the area where the rewrite number is equal to or larger than a predetermined value is selected, so that an area having so poor reliability as not to be used as a write cache can be used as an effective area. Therefore, it is possible to suppress a large increase in capacity of the NAND memory 16. Herein, when data are saved from the write band to the area having poor reliability of the NAND memory 16, even in the case where the data cannot be read from the area, the data remain in the write band, so that it is possible to secure the reliability of the data.

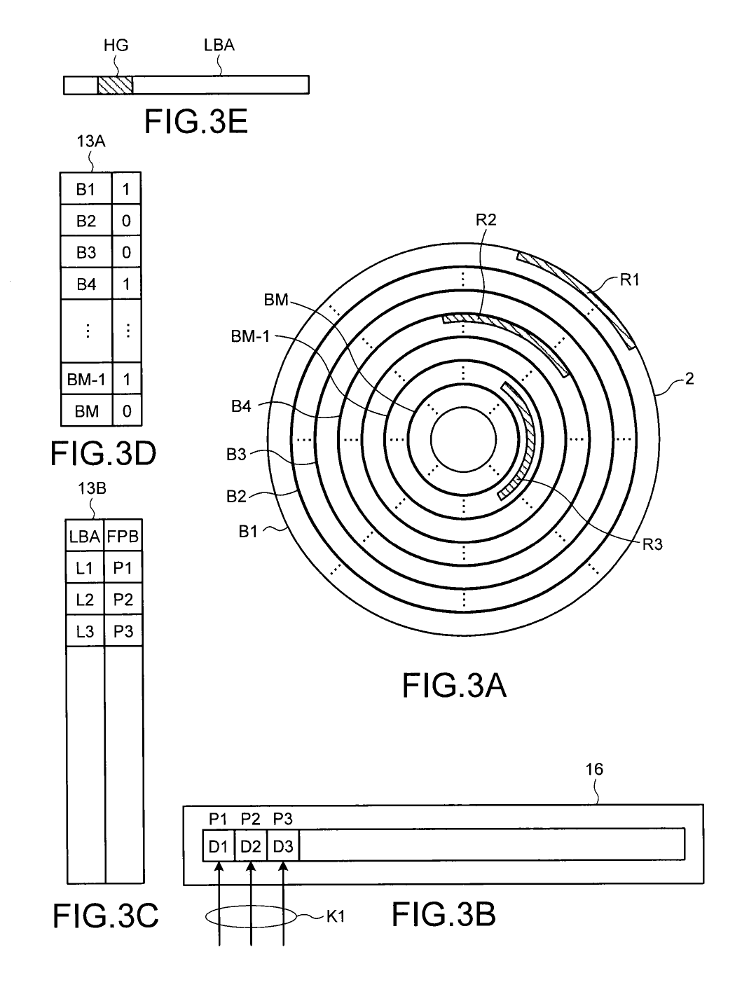

FIG. 3A is a plan view illustrating an example of write positions during random write period of the magnetic disk of FIG. 2A. FIG. 3B is a diagram illustrating a cache state of data written in the magnetic disk of FIG. 3A. FIG. 3C is a diagram illustrating content of a cache management table corresponding to the cache state of FIG. 3B. FIG. 3D is a diagram illustrating content of a dirty counter corresponding to the write positions of FIG. 3A. FIG. 3E is a diagram illustrating a method of allocating a hash value to a logical block address.

In FIGS. 3A to 3D, it is assumed that a write command K1 from the host 17 is designated so that write data D1 are to be written in a region R1 in a band B1 designated by a logical block address L1. At this time, the write data D1 are cached in a cache area P1 of the NAND memory 16, and a correspondence relation between the logical block address L1 and the cache area P1 is recorded in a cache management table 13B.

In addition, as illustrated in FIG. 3E, a hash value HG can be allocated to any bits of the logical block address LBA. For example, if the number M of bands B1 to BM is assumed to be 8, 3 bits as the hash value HGn can be allocated to a predetermined position of the logical block address LBA.

Next, the hash value HG1 is extracted from logical block address L1, and if the hash value HG1 corresponds to the band B1, the count value corresponding to the band B1 of the dirty counter 13A is incremented by 1.

Similarly, it is assumed that the write command K1 from the host 17 is designated so that write data D2 are to be written in a region R2 in a band B4 designated by a logical block address L2. At this time, the write data D2 are cached in a cache area P2 of the NAND memory 16, and a correspondence relation between the logical block address L2 and the cache area P2 is recorded in the cache management table 13B. In addition, a hash value HG2 is extracted from the logical block address L2, and if the hash value HG2 corresponds to the band B4, the count value corresponding to the band B4 of the dirty counter 13A is incremented by 1.

Similarly, it is assumed that the write command K1 from the host 17 is designated so that write data D3 are to be written in a region R3 in a band BM-1 designated by a logical block address L3. At this time, the write data D3 are cached in a cache area P3 of the NAND memory 16, and a correspondence relation between the logical block address L3 and the cache area P3 is recorded in the cache management table 13B. In addition, a hash value HG3 is extracted from the logical block address L3, and if the hash value HG3 corresponds to the band BM-1, the count value corresponding to the band BM-1 of the dirty counter 13A is incremented by 1.

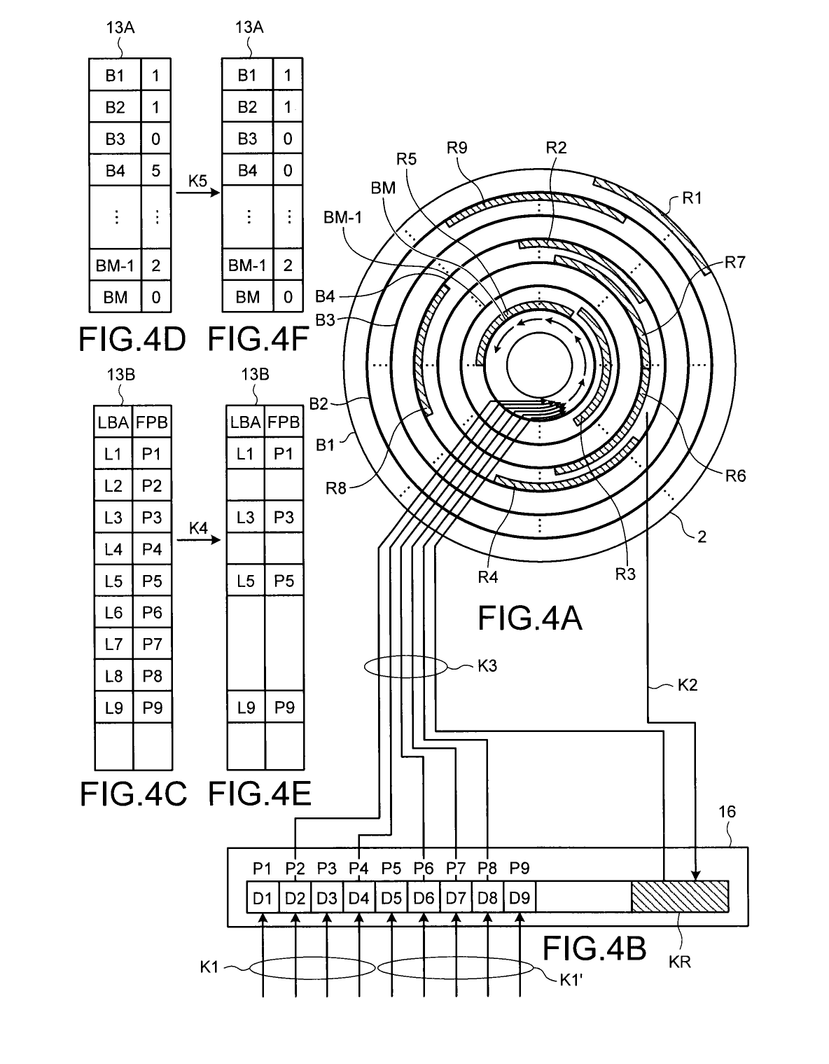

FIG. 4A is a plan view illustrating an example of write positions during random write period of the magnetic disk of FIG. 2A. FIG. 4B is a diagram illustrating a cache state of data written in the magnetic disk of FIG. 4A. FIG. 4C is a diagram illustrating content of a cache management table corresponding to the cache state of FIG. 4B. FIG. 4D is a diagram illustrating content of a dirty counter corresponding to the write positions of FIG. 4A. FIG. 4E is a diagram illustrating content of the cache management table updated after the cache data of FIG. 4B are written in the magnetic disk. FIG. 4F is a diagram illustrating content of the dirty counter updated after the cache data of FIG. 4B are written in the magnetic disk.

In FIGS. 4A to 4D, it is assumed that a write command K1′ from the host 17 is designated so that write data D4 to D9 are to be written in respective regions R4 to R9 designated by logical block addresses L4 to L9. At this time, the write data D4 to D9 are cached in respective cache areas P4 to P9 of the NAND memory 16, and a correspondence relation between the logical block addresses L4 to L9 and the cache areas P4 to P9 is recorded in the cache management table 13B. In addition, hash values HG4 to HG9 are extracted from the respective logical block addresses L4 to L9, and if the hash values HG4 to HG9 correspond to the respective bands B4, BM-1, B4, B4, B4, and B2, each of the count values corresponding to the respective bands B4, BM-1, B4, B4, B4, and B2 of the dirty counter 13A is incremented by 1.

Herein, if it is assumed that the reference value of the count value is set to be 5, in the band B4, since the count value reaches 5, the band B4 is selected as a write band. In addition, with respect to the NAND memory 16, the rewrite number is managed in each storage unit, and a save region KR where the rewrite number is equal to or larger than a predetermined value is searched. Next, data written in a region NR of the band B4 which is not designated by the write commands K1 and K1′ are saved from the band B4 to the save region KR of the NAND memory 16 (K2). Next, the write data D2, D4, and D6 to D8 of the band B4 cached in the NAND memory 16 and the data saved in the save region KR are read from the NAND memory 16 and are written in the band BM of the magnetic disk 2 in a shingled recording format (K3). In addition, as the band BM, an arbitrary band where data are not recorded among the bands B1 to BM can be selected.

Next, as illustrated in FIG. 4E, the cache management table 13B is updated so that the correspondence relation between the logical block addresses L2, L4, and L6 to L8 corresponding to the data D2, D4, and D6 to D9 written in the band B4 and the cache areas P2, P4, and P6 to P8 are removed from the cache management table 13B (K4). In addition, as illustrated in FIG. 4F, the count value corresponding to the band B4 of the dirty counter 13A is cleared to be 0 (K5).

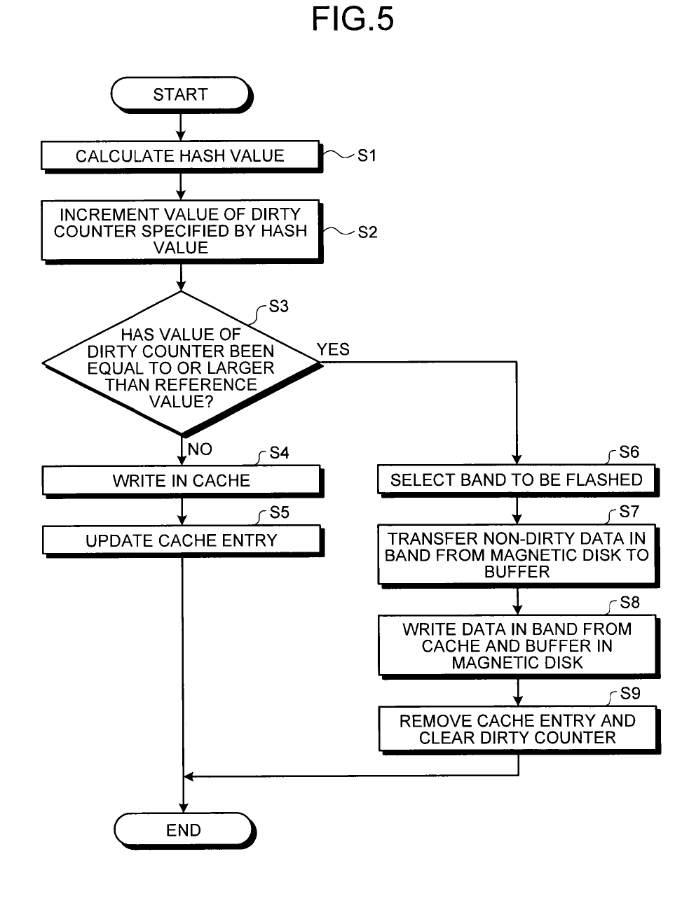

FIG. 5 is a flowchart illustrating process during data write period of the data storage apparatus of FIG. 1.

In FIG. 5, the system controller 13 calculates a hash value from a logical block address included in a write command (S1). Next, a count value of the dirty counter 13A corresponding to a band specified by the hash value is incremented (S2).

Next, it is determined whether or not the count value of the dirty counter 13A is equal to or larger than a reference value (S3). In addition, the count value of the dirty counter 13A can be used to determine whether or not a data amount of one band cached in the NAND memory 16 is larger than a setting amount which is smaller than the capacity of the band. In the case where the count value is smaller than the reference value, the data designated by the write command are written in the cache (S4), and a cache entry is updated (S5). In addition, the NAND memory 16 of FIG. 1 can be used as the cache. In addition, the cache entry may indicate the correspondence relation between the logical block address LBA and the cache area FPB in the cache management table 13B of FIG. 1.

On the other hand, in S3, in the case where the count value of the dirty counter 13A is equal to or larger than the reference value, a flashed band is selected (S6). In addition, non-dirty data in the selected band are transferred from the magnetic disks 2 and 3 to a buffer (S7). In addition, the NAND memory 16 of FIG. 1 can be used as the buffer.

Next, the data in the selected band are written from the cache and the buffer to the magnetic disks 2 and 3 (S8). Next, the cache entry corresponding to the writing is removed, and the count value of the dirty counter 13A corresponding to the selected band is cleared (S9).

In this manner, according to the above-described first embodiment, the data cached in the NAND memory 16 are managed in a storage unit which is smaller than the capacity of each of the bands B1 to BM, so that it is possible to reduce a seek time for the writing in units of band in random writing while suppressing an increase in buffer capacity for writing data back to the magnetic disks 2 and 3.

In addition, in the above-described first embodiment, the method of using the NAND memory 16 as a buffer of allowing data to be cached was described. However, other semiconductor memories such as an SRAM or a DRAM may be used.

### Second Embodiment

In the above-described first embodiment, in the case where the non-dirty data in the selected band are to be transferred from the magnetic disks 2 and 3 to the buffer (write-back cache), the NAND memory 16 of FIG. 1 is used as the buffer. However, a DRAM for performing the write-back cache may be separately installed. In this case, a sum of the capacity of the NAND memory 16 and the capacity of the DRAM may be set to equal to or larger than the capacity of each of the bands B1 to BM.

In the above-described first embodiment, when data in the selected band are to be written from the cache to the magnetic disks 2 and 3, the write-back caching of the non-dirty data in the selected band is performed. However, in the case where the data of the band corresponding to the capacity of the selected band are cached (in other words, updated data of the selected band are cached), the data in the selected band may be written from the cache to the magnetic disks 2 and 3 without performing the write-back caching.

In this manner, according to the above-described second embodiment, in the case where the data of the band corresponding to the capacity of the selected band are cached, there is no need to perform the write-back caching. Therefore, it is possible to reduce a seek time for the writing in units of band in random writing while suppressing an increase in buffer capacity for writing data back to magnetic disks 2 and 3.

### Third Embodiment

In the above-described first embodiment, in the case where there is one band where the count value of the dirty counter 13A is equal to or larger than a reference value, the data of the band are written from the cache and the buffer to the magnetic disks 2 and 3. However, in the case where there is a plurality of bands where the count value of the dirty counter 13A is equal to or larger than the reference value, the data of the band may be written from the cache and the buffer to the magnetic disks 2 and 3.

In this manner, according to the above-described third embodiment, the data of the plurality of bands can be written from the cache and the buffer to the magnetic disks 2 and 3, so that it is possible to reduce a seek time for the writing in units of band in random writing.

### Fourth Embodiment

In the above-described first embodiment, in the case where a flashed band is to be selected, non-dirty data in the selected band are transferred from the band to the buffer. However, in the case where the non-dirty data in the selected band are read-cached in the NAND memory 16, the data in the selected band may be written from the cache to the magnetic disks 2 and 3 without transferring the non-dirty data in the selected band from the band to the buffer.

In this manner, according to the above-described fourth embodiment, in the case where the non-dirty data in the selected band are read-cached in the NAND memory 16, there is no need to transfer the non-dirty data in the selected band from the band to the buffer, so that it is possible to reduce a seek time for the writing in units of band in random writing.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A data storage apparatus comprising:
a magnetic disk where writing is performed in units of band which is a collection of a plurality of adjacent tracks;
a magnetic recording control unit performs writing on the magnetic disk in units of band;
a NAND memory caches data to be written in the magnetic disk;
a NAND controller manages data cached in the NAND memory in units of capacity smaller than capacity of the band and performs control of the NAND memory; and
a system controller controls data exchange between the magnetic disk and the NAND memory,
wherein the system controller includes:
a dirty counter counts the number of data written in the band based on a hash value extracted from a logical block address included in a write command for each band;
a write selection unit selects a write band of the magnetic disk based on a count value of the dirty counter;
a saving unit saves data written in a logical block address which is not designated by the write command and of the selected write band from the selected write band to the NAND memory; and
a writing unit reads the cached data and the saved data from the NAND memory and writes the read data in the write band of the magnetic disk.

2. A data storage apparatus comprising:
a magnetic disk where writing is performed in units of band which is a collection of a plurality of adjacent tracks;
a semiconductor memory caches data to be written in the magnetic disk; and
a controller manages the data cached in the semiconductor memory in units of capacity smaller than capacity of the band.

3. The data storage apparatus of claim 2, wherein, in the case where the number of data cached in the semiconductor memory based on a write command is smaller than capacity of a write band in which the data are to be written, the controller saves data written in an area of the write band which is not designated by the write command to an area of the semiconductor memory where the rewrite number is equal to or larger than a predetermined value, reads the cached data and the saved data from the semiconductor memory, and writes the read data in the write band.

4. The data storage apparatus of claim 3, wherein, in the case where there are a plurality of bands where a data amount of one band cached in the semiconductor memory based on the write command is larger than a setting amount smaller than the capacity of the band, the controller saves the data written in the area which is not designated by the write command from the plurality of bands to an area of the semiconductor memory where the rewrite number is equal to or larger than a predetermined value, reads the cached data and the saved data from the semiconductor memory, and writes the read data in the plurality of bands.

5. The data storage apparatus of claim 2, wherein, in the case where a data amount of one band cached in the semiconductor memory is larger than a setting amount smaller than capacity of the band, the controller writes the data from the semiconductor memory to the band of the magnetic disk.

6. The data storage apparatus of claim 3, wherein the band in which the cached data and the saved data are written is a band other than the band from which the saved data are read.

7. A data storage control method of a data storage apparatus having a magnetic disk where writing is performed in units of band which is a collection of a plurality of adjacent tracks and a semiconductor memory caches data to be written in the magnetic disk, the method comprising:
in the case where the number of data cached in the semiconductor memory based on a write command is smaller than capacity of a write band in which the data are to be written, saving data written in an area of the write band which is not designated by the write command to an area of the semiconductor memory where the rewrite number is equal to or larger than a predetermined value;
reading the cached data and the saved data from the semiconductor memory; and
writing the read data in the write band.

8. The data storage control method of claim 7, wherein the data cached in the semiconductor memory are managed in units of capacity smaller than capacity of the band.

9. The data storage control method of claim 7, the method further comprising:
in the case where there are a plurality of bands where a data amount of one band cached in the semiconductor memory based on the write command is larger than a setting amount smaller than the capacity of the band, saving the data written in the area which is not designated by the write command from the plurality of bands to an area of the semiconductor memory where the rewrite number is equal to or larger than a predetermined value;
reading the cached data and the saved data from the semiconductor memory; and
writing the read data in the plurality of bands.

10. The data storage control method of claim 7, further comprising:
in the case where a data amount of one band cached in the semiconductor memory is larger than a setting amount smaller than capacity of the band, writing the data from the semiconductor memory to the band of the magnetic disk.

11. The data storage control method of claim 7, wherein the band in which the cached data and the saved data are written is a band other than the band from which the saved data are read.

12. The data storage control method of claim 7, further comprising:
counting the number of data written in the band based on a hash value extracted from a logical block address included in the write command for each band;
selecting a write band of the magnetic disk based on the counted value;
saving data written in a logical block address of the selected band which is not designated by the write command from the selected write band to the NAND memory; and
reading the cached data and the saved data from the NAND memory and writing the read data in the write band of the magnetic disk.
